(19) United States
(12) Patent Application Publication
(10) Pub. No.: US 2013/0083168 A1
(43) Pub. Date: Apr. 4, 2013

(54) CALIBRATION APPARATUS FOR CAMERA MODULE

(71) Applicants: Joo Hyun KIM, Hwaseong (KR); Jagarlamudi Veera Venkata PRASAD, Bengaluru (IN); Nagaraj AVINASH, Bengaluru (IN); Soon Seok KANG, Yongin (KR)

(72) Inventors: Joo Hyun KIM, Hwaseong (KR); Jagarlamudi Veera Venkata PRASAD, Bengaluru (IN); Nagaraj AVINASH, Bengaluru (IN); Soon Seok KANG, Yongin (KR)

(73) Assignee: SAMSUNG ELCTRO-MECHANICS CO., LTD., Suwon (KR)

(21) Appl. No.: 13/339,617

(22) Filed: Dec. 29, 2011

(30) Foreign Application Priority Data
Sep. 30, 2011 (KR) 10-2011-0099717

(51) Int. Cl. H04N 13/02; H04N 17/06

(52) U.S. Cl. 348/47; 348/187; 348/188; 348/E13.074; 348/E13.014; 348/E13.016; 348/E17.002

(57) ABSTRACT

There is provided a calibration apparatus for a camera module capable of calibrating the difference in optical characteristics between left and right images of a binocular camera module in real time by capturing images of a plurality of rotating test boards. The calibration apparatus of a camera module includes: a test unit including two or more mutually connected test boards, the test boards having images captured by a camera module and rotating at a pre-set angle; and a calibration unit receiving the images of the test boards captured by the camera module and calibrating optical characteristics thereof.

### CROSS-REFERENCE TO RELATED APPLICATIONS

This application claims the priority of Korean Patent Application No. 10-2011-0099717 filed on Sep. 30, 2011, in the Korean Intellectual Property Office, the disclosure of which is incorporated herein by reference.

### BACKGROUND OF THE INVENTION

1. Field of the Invention

The present invention relates to a calibration apparatus for a camera module capable of calibrating optical characteristics of a captured image in real time.

2. Description of the Related Art

Recently, the prevalence of 3D TVs, 3D monitors, and the like, has promoted the development of a 3D camera for capturing 3D content and for the production of 3D content.

Various methods have been provided to realize a 3D camera, and generally, a binocular camera using two image sensors and two lenses is commonly used because it is relatively low-priced and can be easily fabricated. Two images having a binocular disparity similar to that of human eyes may be obtained by using such a binocular camera, and 3D stereoscopic images may be viewed by applying the images captured by the binocular camera to a device available for 3D display such as a 3D TV, a 3D monitor, or the like.

Meanwhile, the binocular camera obtains images with two camera modules each having an image sensor and a lens, and when a positional error occurs in the two camera modules obtaining images during an assembly process thereof, a positional error also occurs in a captured image, thereby causing a viewer to feel dizzy and experience visual inconvenience. Also, operational conditions with regard to automatic exposure and automatic white balance of the image sensors that process images may be changed, due to the difference in views of the two camera modules, resulting in left and right images having a differently sensed colors and brightness levels, which may also cause a viewer to feel dizzy and experience visual inconvenience.

### SUMMARY OF THE INVENTION

An aspect of the present invention provides a calibration apparatus for a camera module capable of calibrating difference in optical characteristics between left and right images of a binocular camera module by capturing images of a plurality of rotating test boards.

According to an aspect of the present invention, there is provided a calibration apparatus for a camera module, including: a test unit including two or more mutually connected test boards, the test boards having images captured by a camera module and rotating at a pre-set angle; and a calibration unit receiving the images of the test boards captured by the camera module and calibrating optical characteristics thereof.

The test unit may include a test board unit in which the test boards include respective test charts having the images captured by the camera module and at least portions of the respective test boards are connected along circumferences thereof; and a drive unit rotating the test board unit at a pre-set angle.

The test board unit may include five test boards, at least portions of which are connected along circumferences thereof.

Each of the test boards may have a line of a pre-set color formed along a circumference of each of the test charts.

The camera module may be a binocular camera module.

The binocular camera module may include a binocular image capturing unit capturing the images of the test boards and transferring the captured images to the calibration unit; a storage unit storing a calibration value from the calibration unit; and a position calibration unit calibrating the captured images of the binocular image capturing unit according to the calibration value from the storage unit.

The binocular camera module may further include a color calibration unit calibrating color levels of the images calibrated by the position calibration unit.

The calibration unit may calibrate at least one of a distorted optical axis, and color and brightness levels between left and right images captured by the binocular camera module.

The calibration unit may calibrate the optical characteristics of the images of the test boards captured by the binocular camera module according to an algorithm known as “Comparison of Stereo Matching Algorithms for Mobile Robots” by Annika Kuhl and an algorithm known as “Flexible New Technique for Camera Calibration” by ZhengyouZhang.

The calibration unit may calibrate optical characteristics of 15 images of the test boards captured by the binocular camera module.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a calibration apparatus according to an embodiment of the present invention;

FIGS. 2A through 2C and 3 are views showing examples of test boards employed in a calibration apparatus according to an embodiment of the present invention;

FIG. 4 is a view showing a calibration method of a calibration apparatus according to an embodiment of the present invention;

FIGS. 5A and 5B are views showing left and right images each having a distorted optical axis;

FIGS. 6A and 6B are views showing calibrated left and right images;

FIGS. 7A and 7B are views showing left and right images having different colors;

FIGS. 8A and 8B are views showing calibrated left and right images; and

FIGS. 9 and 10 are graphs showing a processing time and a pixel error according to the number of sheets of images, respectively.

### DETAILED DESCRIPTION OF THE INVENTION

Embodiments of the present invention will now be described in detail with reference to the accompanying drawings.

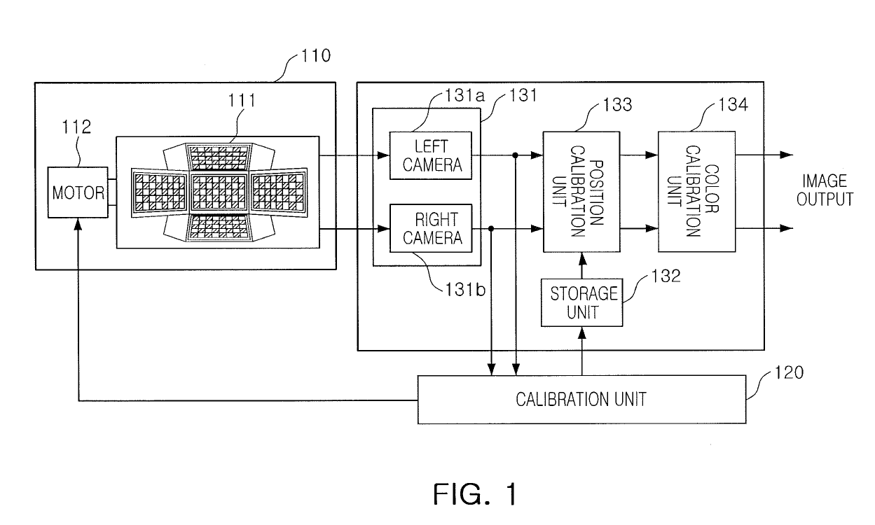

FIG. 1 is a schematic block diagram of a calibration apparatus according to an embodiment of the present invention.

With reference to FIG. 1, a calibration apparatus 100 according to an embodiment of the present invention may include a test unit 110 and a calibration unit 120. The calibration apparatus 100 may calibrate images captured by a camera module 130.

The test unit 110 may include a test board unit 111 and a drive unit 112.

The test board unit 111 may include a plurality of test boards. Each of the plurality of test boards may have a test chart having images captured by the camera module 130. At least portions of the plurality of test boards may be connected along the circumferences thereof. For example, when the test boards have a quadrangular shape having a certain width and a certain length, one horizontal facet or vertical facet of the plurality of test boards may be connected.

As illustrated, when the test boards have a quadrangular shape, five test boards may be connected with each other. Namely, based on one central test board, horizontal and vertical facets of the central test board are connected with a respective horizontal or vertical facet of the remaining test boards, so that five test boards can be connected with each other. Accordingly, when the camera module 130 performs a single imaging operation, a plurality of test images, in particular, 35 test images, may be simultaneously obtained.

The drive unit 112 may rotate the test board unit 111 at a pre-set angle. In order to calibrate optical characteristics in the camera module 130, several sheets of test images should be acquired. Generally, the binocular camera module 130 acquires 15 left images and 15 right images and calibrates optical characteristics thereof. Here, the binocular camera module 130 acquires a test image set by capturing an image from various directions, and the drive unit 112 according to an embodiment of the present invention rotates the plurality of mutually connected test boards in a pre-set direction.

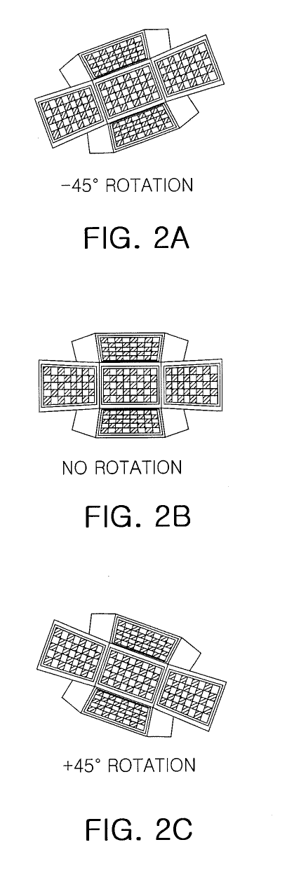

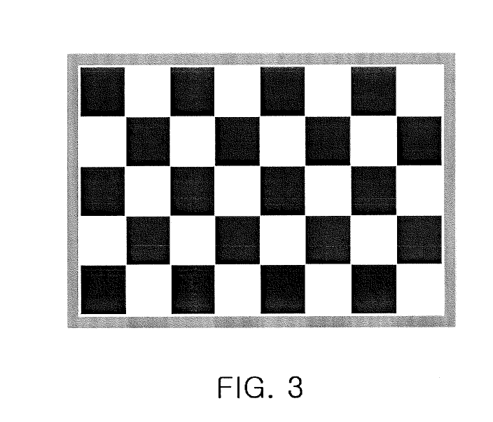

FIGS. 2A through 2C and 3 are views showing examples of test boards employed in a calibration apparatus according to an embodiment of the present invention.

For example, as shown in FIGS. 2A through 2C, the drive unit 112 may rotate the test boards at −45°, 0°, and +45° to allow the camera module 130 to easily capture test images. Namely, when the five test boards are rotated in three directions, 15 images for calibrating the optical characteristics thereof may be easily acquired. As the foregoing rotation angles, various rotation angles may be selected.

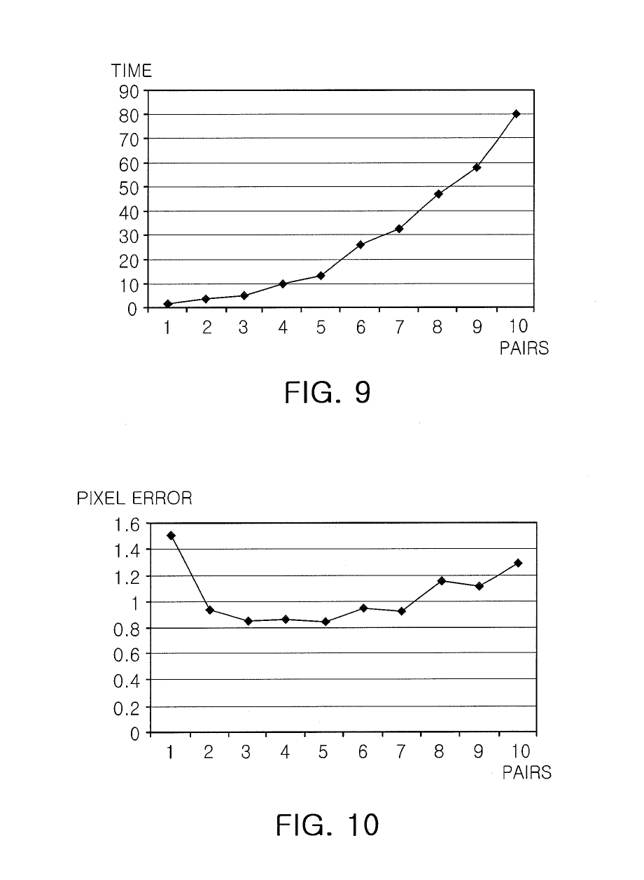

As described above, the images of the five test boards are captured in a single imaging operation to thereby obtain a total of three sheets of images. Here, as the sheets of images are increased, an image processing time is increased as shown in FIGS. 9 and 10. With reference to FIG. 9, it is noted that the image processing time is not greatly increased over one to five sheets of images, and with reference to FIG. 10, it is noted that a pixel error is smallest over three to five sheets of images.

In particular, the reason for obtaining a total of 15 images by obtaining three sheets of images is as shown in Table below.

TABLE

| Image Pairs | Time | Pix. Err |
|---|---|---|
| 1 | 1.406 | 1.500014 |
| 2 | 3.375 | 0.943246 |
| 3 | 5.36 | 0.85666 |
| 4 | 9.484 | 0.859471 |
| 5 | 13.266 | 0.841277 |
| 6 | 25.953 | 0.945735 |
| 7 | 32.563 | 0.915687 |
| 8 | 47.031 | 1.15406 |
| 9 | 57.643 | 1.107417 |
| 10 | 79.565 | 1.282892 |

As shown in Table above, it is noted that obtaining three sheets of images is an optimum value in consideration of time and pixel errors.

Meanwhile, a test chart is formed in the test board. In order to allow the camera module 130 to accurately recognize the test chart, a line of a pre-set color, e.g., a red line, may be formed along the circumference of the test chart.

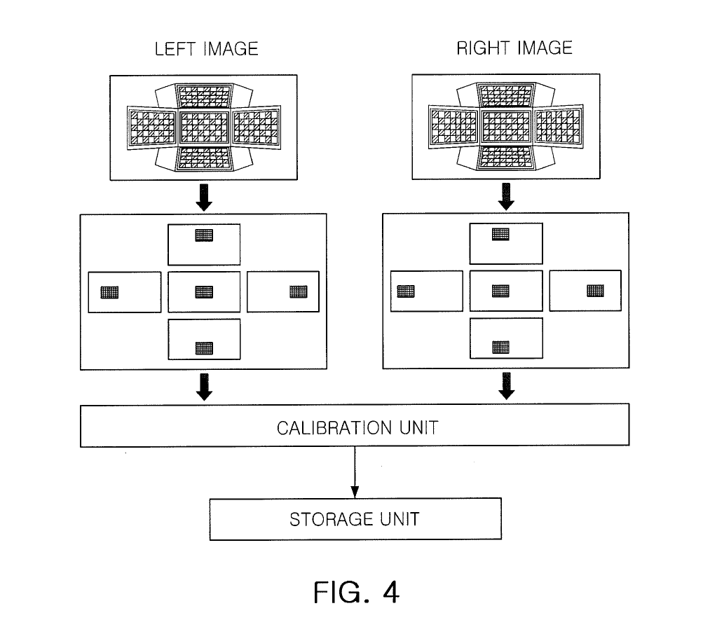

FIG. 4 is a view showing a calibration method of the calibration apparatus according to an embodiment of the present invention.

With reference to FIGS. 1 through 4, in the calibration apparatus according to the embodiment of the present invention, a left camera 131a and a right camera 131b of a binocular image capturing unit 131 of the camera module 130 capture test images, respectively, and to this end, the five test boards each having a test chart may be connected with each other and rotated in three directions in the test board unit 111 of the test unit 110. The left camera 131a and the right camera 131b may obtain 15 test images, respectively. The obtained images may be transferred to the calibration unit 120. The calibration unit 120 may calibrate an optical difference between the obtained left and right images and transfer the same to a storage unit 132. The storage unit 132 may transfer the received images to a position calibration unit 133, so that the captured images can be calibrated according to a calibration value. In addition, a color calibration unit 134 may calibrate the color of the captured left and right images.

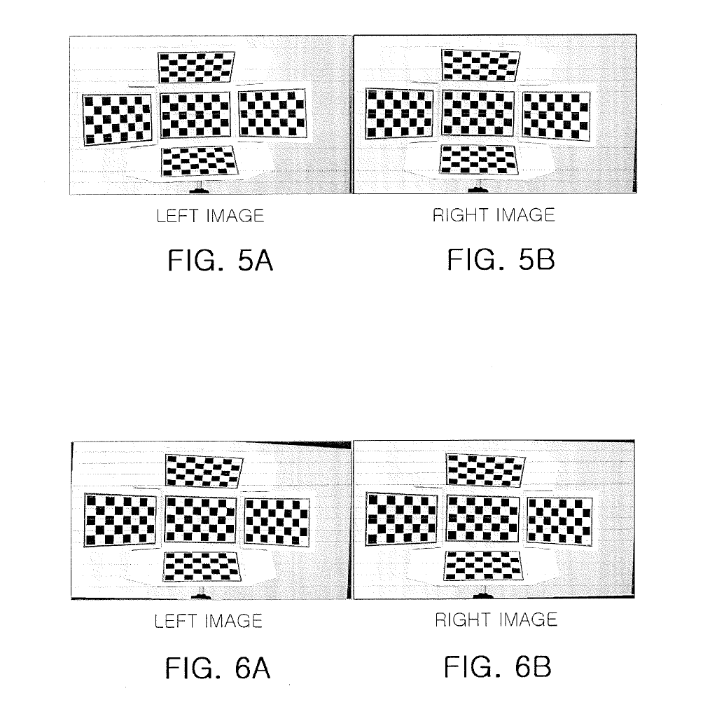

FIGS. 5A and 5B are views showing left and right images each having a distorted optical axis, and FIGS. 6A and 6B are views showing calibrated left and right images.

As shown in FIG. 5, the images captured by the left camera 131a and the right camera 131b of the camera module 130 may have distorted optical axes, and the calibration unit 120 may extract a calibration value for calibrating the distorted optical axes between the left and right images.

The calibration unit 120 may extract a calibration value from the 15 left and right images obtained from the camera module 130. Here, the calibration unit 120 may extract the calibration value from the 15 left and right images obtained from the camera module 130 according to an algorithm known as “Comparison of Stereo Matching Algorithms for Mobile Robots” by Annika Kuhl and an algorithm known as “Flexible New Technique for Camera Calibration” by ZhengyouZhang.

In detail, the calibration unit 120 may extract first to fourth optical characteristic values of the left and right cameras from the 15 left and right images obtained from the camera module 130. Here, the first to fourth optical characteristic values may be defined as expressed by Equation 1 shown below:

$${M}_{new} = [ \begin{matrix}{f}_{x}^{′} & 0 & {C}_{x}^{′} \\ 0 & {f}_{y}^{′} & {C}_{y}^{′} \\ 0 & 0 & 1\end{matrix} ] \\ {M}_{old} = [ \begin{matrix}{f}_{x} & 0 & {C}_{x} \\ 0 & {f}_{y} & {C}_{y} \\ 0 & 0 & 1\end{matrix} ] \\ D = [ \begin{matrix}{k}_{1} & {k}_{2} & {p}_{1} & {p}_{2} & {k}_{3}\end{matrix} ] \\ R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] \qquad [ Equation 1 ]$$

Here, Mnew, Mold, D, and R are first to fourth optical characteristic values, respectively. In Equation 1, fx of the first and second optical characteristic values Mnew and Mold is a value obtained by dividing a focal length of the camera by a physical horizontal length of the image sensor, fy is a value obtained by dividing the focal length of the camera by a physical vertical length of the image sensor, Cx is a horizontal position of the central coordinates of the camera, and Cy is a vertical position of the central coordinates of the camera. K1, K2, P1, P2, and K3 of the third optical characteristic value D are distortion coefficients of a camera lens, and R11, R12, R13, R21, R22, R23, R31, R32, and R33 of the fourth optical characteristic value R are conversion coefficients for compensating for a positional error of the left camera and the right camera.

The first to fourth optical characteristic values may be extracted according to an algorithm known as “Comparison of Stereo Matching Algorithms for Mobile Robots” by Annika Kuhl and an algorithm known as “Flexible New Technique for Camera Calibration” by ZhengyouZhang.

In order to calibrate the distorted optical axes of the left and right images by using the first to fourth optical characteristic values, a method as shown in Equation 2 below is used.

x=(u−C′ₓ)/f′ₓ

y=(v−C′_{y})/f′_{y} [Equation 2]

Here, u is horizontal coordinates of an input pixel and v is vertical coordinates of the input pixel.

Based on this, a positional error of the left and right cameras is compensated for as expressed by Equation 3 shown below:

[XYW]^{T}=R⁻¹[xy1]^{T} [Equation 3]

Here, W is a scale factor, and X and Y can be normalized by using the scale factor as expressed by Equation 4 shown below:

x′=X/W

y′=Y/W [Equation 4]

Compensation of a lens distortion in the normalized x′, y′ may be performed as expressed by Equation 5 shown below:

x″=x′(1+k₁r²+k₂r⁴+k₃r⁶)+2p₁x′y′+p₂(r²+2x′²)

y″=y′(1+k₁r²+k₂r⁴+k₃r⁶)+p₁(r²+2y′²)+2p₂x′y′) [Equation 5]

The coordinates of the cameras whose position and lens distortion have been compensated for as expressed by Equation 5 may be converted into image coordinates as expressed by Equation 6 to obtain final image coordinates.

u_{—}uc=x″fₓ+Cₓ

v_{—}uc=y″f_{y}+C_{y} [Equation 6]

Here, u_uc and v_uc indicate positions to which the coordinates u,v of the original image should be moved. For example, when the image coordinates (u,v) are (1,1), this indicates a first pixel of a first line of a captured image, and in this case, when final image coordinates (u_uc, v_vc) as expressed by Equation 6 are (3,4), it indicates that the pixel data (1,1) should be moved to position (3,4). The position calibration unit 133 calibrates the position of the pixel data of the captured image according to the calibration value stored in the storage unit 132 to thus calibrate the distorted optical axes of the left and right images.

Accordingly, it is noted that the left and right images having the distorted optical axes as shown in FIG. 5 are calibrated such that the positions of the left and right images are consistent as shown in FIG. 6.

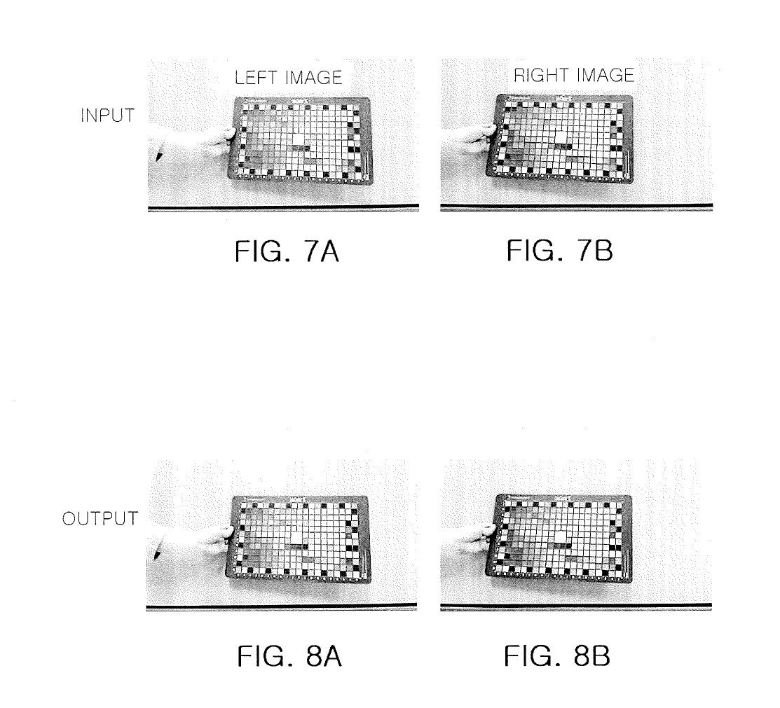

FIGS. 7A and 7B are views showing left and right images having different color levels, and FIGS. 8A and 8B are views showing calibrated left and right images.

With reference to FIG. 1, views captured by the left and right cameras 131a and 131b of the camera module 130 may be different due to binocular disparity, resulting in left and right images having different brightness levels and colors. The color calibration unit 134 may calibrate the difference in color levels between the captured left and right images.

The color calibration unit 134 may calibrate the difference in color levels by using a color space of YCbCr as expressed by Equation 7 below:

Y_mean_left=Y_{—}sum_left/total_pixel_number

Cb_mean_left=Y_{—}sum_left/total_pixel_number

Cr_mean_left=Y_{—}sum_left/total_pixel_number

Y_mean_right=Y_{—}sum_right/total_pixel_number

Cb_mean_right=Y_{—}sum_right/total_pixel_number

Cr_mean_right=Y_{—}sum_right/total_pixel_number [Equation 7]

Here, Y is a brightness level, and Cb and Cr are color difference signals. Respective average Y, Cb, and Cr values of the left and right images may be obtained.

In order to calibrate the image of the right camera based on the color and the brightness level of the image of the left camera, the difference between the respective average Y, Cb, and Cr values between the left and right images is obtained and normalized as expressed by Equation 8 shown below:

Y_right_diff=(Y_mean_left−Y_mean_right)/L

Cb_right_diff=(Cb_mean_left−Cb_mean_right)/L

Cr_right_diff=(Cr_mean_left−Cr_mean_right)/L [Equation 8]

Here, L is to normalize the difference in values, and for example, in the case of an 8-bit image signal, L may be set to be 256.

Here, in order to calibrate the image of the right camera based on the color and the brightness level of the image of the left camera, it can be processed as expressed by Equation 9 shown below:

Y_right_output=(1+Y_right_diff)*Y_right_input

Cb_right_output=(1+Cb_right_diff)*Cb_right_input

Cr_right_output=(1+Cr_right_diff)*Cr_right_input [Equation 9]

Here, Y_right_input is a brightness level of an input pixel of the right camera, and Y_right_output is calibrated brightness level of the right camera. Since the image of the right camera is calibrated based on the image of the left camera, the image of the left camera is not calibrated. According to the foregoing method, the image of the left camera may be calibrated based on the image of the right camera, and in this case, ‘left’ and ‘right’ in Equations 8 and 9 may be interchangably applied.

The color calibration unit 134 may calibrate the brightness and color levels of the right image or the left image based on the brightness and color levels of the left image or the right image according to the stored calibration value.

Accordingly, the left and right images having different color levels as shown in FIG. 7 may be calibrated into left and right images having a consistent color level as shown in FIG. 8.

In this manner, according to an embodiment of the invention, the difference in optical characteristics between left and right images of the binocular camera module can be calibrated in real time by capturing images of a plurality of rotating test boards.

As set forth above, according to embodiments of the invention, the difference in optical characteristics between left and right images of a binocular camera module can be calibrated in real time by capturing images of a plurality of rotating test boards, thereby calibrating the distorted optical axes of the left and right images and the difference in color and brightness levels.

While the present invention has been shown and described in connection with the embodiments, it will be apparent to those skilled in the art that modifications and variations can be made without departing from the spirit and scope of the invention as defined by the appended claims.

What is claimed is:

1. A calibration apparatus of a camera module, the apparatus comprising:
a test unit including two or more mutually connected test boards, the test boards having images captured by a camera module and rotating at a pre-set angle; and
a calibration unit receiving the images of the test boards captured by the camera module and calibrating optical characteristics thereof.

2. The calibration apparatus of claim 1, wherein the test unit includes:
a test board unit in which the test boards include respective test charts having the images captured by the camera module and at least portions of the respective test boards are connected along circumferences thereof; and
a drive unit rotating the test board unit at a pre-set angle.

3. The calibration apparatus of claim 2, wherein the test board unit includes five test boards, at least portions of which are connected along circumferences thereof.

4. The calibration apparatus of claim 2, wherein each of the test boards has a line of a pre-set color formed along a circumference of each of the test charts.

5. The calibration apparatus of claim 1, wherein the camera module is a binocular camera module.

6. The calibration apparatus of claim 5, wherein the binocular camera module includes:
a binocular image capturing unit capturing the images of the test boards and transferring the captured images to the calibration unit;
a storage unit storing a calibration value from the calibration unit; and
a position calibration unit calibrating the captured images of the binocular image capturing unit according to the calibration value from the storage unit.

7. The calibration apparatus of claim 6, wherein the binocular camera module further includes a color calibration unit calibrating color levels of the images calibrated by the position calibration unit.

8. The calibration apparatus of claim 5, wherein the calibration unit calibrates at least one of a distorted optical axis, and color and brightness levels between left and right images captured by the binocular camera module.

9. The calibration apparatus of claim 8, wherein the calibration unit calibrates the optical characteristics of the images of the test boards captured by the binocular camera module according to an algorithm known as “Comparison of Stereo Matching Algorithms for Mobile Robots” by Annika Kuhl and an algorithm known as “Flexible New Technique for Camera Calibration” by ZhengyouZhang.

10. The calibration apparatus of claim 9, wherein the calibration unit calibrates optical characteristics of 15 images of the test boards captured by the binocular camera module.
